(19) United States
(12) Patent Application Publication
(10) Pub. No.: US 2014/0204863 A1
(43) Pub. Date: Jul. 24, 2014

(54) Method of Reducing Reference Signals and Communication Device thereof

(71) Applicant: HTC Corporation, Taoyuan County (TW)

(72) Inventor: Chih-Yao Wu, Taoyuan County (TW)

(73) Assignee: HTC Corporation, Taoyuan County (TW)

(21) Appl. No.: 14/158,870

(22) Filed: Jan. 20, 2014

Related U.S. Application Data
(60) Provisional application No. 61/753,952, filed on Jan. 18, 2013.

(51) Int. Cl. H04L 5/00

(52) U.S. Cl. CPC H04L 5/0051
USPC 370/329

(57) ABSTRACT

A method of reducing a number of reference signals for a communication device in a wireless communication system, includes receiving a downlink control information (DCI) message in a first bundling subframe of a plurality of bundling subframes, wherein the bundling subframes are contiguous subframes; receiving reference signals with a reduced pattern in the plurality of bundling subframes, wherein a number of the reference signals with the reduced pattern is smaller than a number of the reference signals determined in corresponding specifications; measuring channel responses according to the reference signals with the reduced pattern; using the channel responses to perform channel interpolations in the plurality of bundling subframes, for acquiring channel estimations of the plurality of the bundling subframes; and receiving data according to the DCI message in the plurality of bundling subframes.

### CROSS REFERENCE TO RELATED APPLICATIONS

This application claims the benefit of U.S. Provisional Application No. 61/753,952, filed on Jan. 18, 2013 and entitled “Method and Apparatus for Spectral Efficiency Improvement under Small Cell Deployment for Wireless Communication Systems”, the contents of which are incorporated herein in their entirety.

### BACKGROUND OF THE INVENTION

1. Field of the Invention

The present disclosure relates to a method for a wireless communication systems and communication device thereof, and more particularly, to a method of reducing reference signals and communication device thereof.

2. Description of the Prior Art

A long-term evolution (LTE) system supporting the 3rd Generation Partnership Project (3GPP) Rel-8 standard and/or the 3GPP Rel-9 standard are developed by the 3GPP as a successor of a universal mobile telecommunications system (UMTS), for further enhancing performance of the UMTS to satisfy increasing needs of users. The LTE system includes a new radio interface and a new radio network architecture that provides a high data rate, low latency, packet optimization, and improved system capacity and coverage. In the LTE system, a radio access network known as an evolved universal terrestrial radio access network (E-UTRAN) includes multiple evolved Node-Bs (eNBs) for communicating with multiple user equipments (UEs), and for communicating with a core network including a mobility management entity (MME), a serving gateway, etc., for Non-Access Stratum (NAS) control.

A LTE-advanced (LTE-A) system, as its name implies, is an evolution of the LTE system. The LTE-A system targets faster switching between power states, improves performance at the coverage edge of an eNB, and includes advanced techniques, such as carrier aggregation (CA), coordinated multipoint (COMP) transmission/reception, UL multiple-input multiple-output (MIMO), etc. For a UE and an eNB to communicate with each other in the LTE-A system, the UE and the eNB must support standards developed for the LTE-A system, such as the 3GPP Rel-10 standard or later versions.

In addition, small cell deployment with low power transmission nodes (e.g. pico cell and femto cell) for hotspot zone has drawn a lot of interests on the next generation of the wireless communication systems (e.g. LTE-A system) and the wireless standards. Compared to a macrocell that may have a range of a few tens of kilometers (KMs), the small cell has a range of 10 meters to 1 or 2 KMs. The small cell can be used to provide in-building and outdoor wireless service. Via the small cells, the capacity of the network can be improved and the wireless channel gain of the UE can be enhanced. The small cell becomes a vital function in the next generation of the wireless communication systems and the wireless standards, therefore.

Thus, how to operate the small cell deployment, efficiently, becomes an important topic to be discussed.

### SUMMARY OF THE INVENTION

In order to solve the above problem, the present disclosure provides a method of reducing reference signals and communication device thereof.

The present disclosure discloses a method of reducing a number of reference signals for a communication device in a wireless communication system, the method comprising receiving a downlink control information (DCI) message in a first bundling subframe of a plurality of bundling subframes, wherein the bundling subframes are contiguous subframes; receiving reference signals with at least one reduced pattern in the plurality of bundling subframes, wherein a number of the reference signals with the reduced pattern is smaller than a number of the reference signals determined in corresponding specifications; measuring channel responses according to the reference signals with the reduced pattern; using the channel responses to perform channel interpolations in the plurality of bundling subframes, for acquiring channel estimations of the plurality of the bundling subframes; and receiving data according to the DCI message in the plurality of bundling subframes.

The present disclosure further discloses a method of reducing reference signals for a network of a wireless communication system, the method comprising transmitting a downlink control information (DCI) message in a first bundling subframe of a plurality of bundling subframes, wherein the bundling subframes are contiguous subframes; transmitting reference signals with at least one reduced pattern in the plurality of bundling subframes, wherein a number of the reference signals with the reduced pattern is smaller than a number of the reference signals determined in corresponding specifications; and transmitting data according to the DCI message in the plurality of bundling subframes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present disclosure.

FIG. 2 is a schematic diagram of a communication device according to an example of the present disclosure.

FIG. 3 is a flowchart of a process according to an example of the present disclosure.

FIG. 4 is a schematic diagram of a plurality of bundling subframes according to an example of the present disclosure.

FIG. 5 is a flowchart of a process according to an example of the present disclosure.

### DETAILED DESCRIPTION

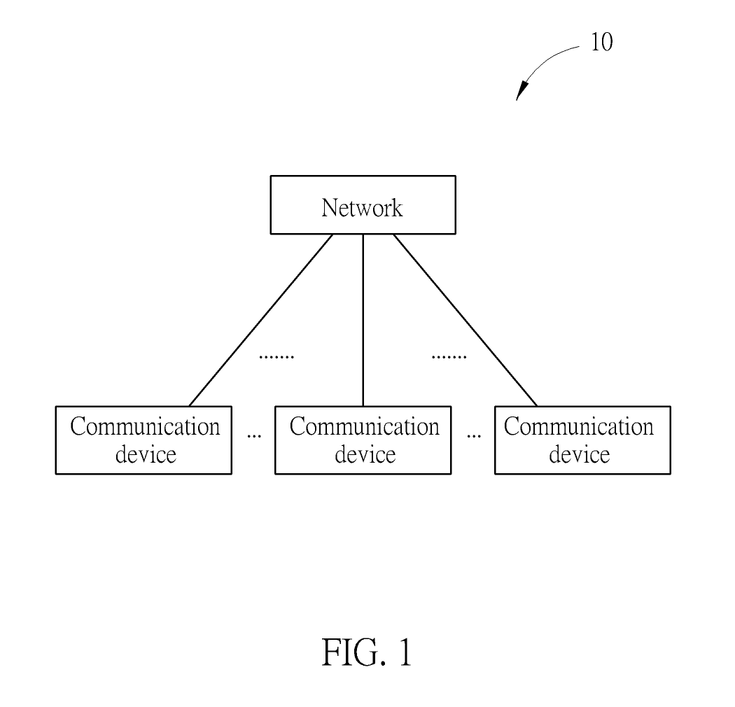

Please refer to FIG. 1, which is a schematic diagram of a wireless communication system 10 according to an example of the present disclosure. The wireless communication system 10 is briefly composed of a network and a plurality of communication devices. In FIG. 1, the network and the communication devices are simply utilized for illustrating the structure of the wireless communication system 10. Practically, the network can be a small cell network, a universal terrestrial radio access network (UTRAN) comprising a plurality of Node-Bs (NBs) in a universal mobile telecommunications system (UMTS). In another example, the network can be an evolved UTRAN (E-UTRAN) comprising a plurality of evolved NBs (eNBs) and/or relays in a long term evolution (LTE) system, a LTE-Advanced (LTE-A) system or an evolution of the LTE-A system.

Furthermore, the network can also include both the UTRAN/E-UTRAN and a core network, wherein the core network includes network entities such as Mobility Management Entity (MME), Serving Gateway (S-GW), Packet Data Network (PDN) Gateway (P-GW), Self-Organizing Networks (SON) server and/or Radio Network Controller (RNC), etc. In other words, after the network receives information transmitted by a communication device, the information may be processed only by the UTRAN/E-UTRAN and decisions corresponding to the information are made at the UTRAN/E-UTRAN. Alternatively, the UTRAN/E-UTRAN may forward the information to the core network, and the decisions corresponding to the information are made at the core network after the core network processes the information. Besides, the information can be processed by both the UTRAN/E-UTRAN and the core network, and the decisions are made after coordination and/or cooperation are performed by the UTRAN/E-UTRAN and the core network. A communication device can be a user equipment (UE), a mobile phone, a laptop, a tablet computer, an electronic book or a portable computer system. Besides, the network and the communication device can be seen as a transmitter or a receiver according to direction, e.g., for an uplink (UL), the communication device is the transmitter and the network is the receiver, and for a downlink (DL), the network is the transmitter and the communication device is the receiver.

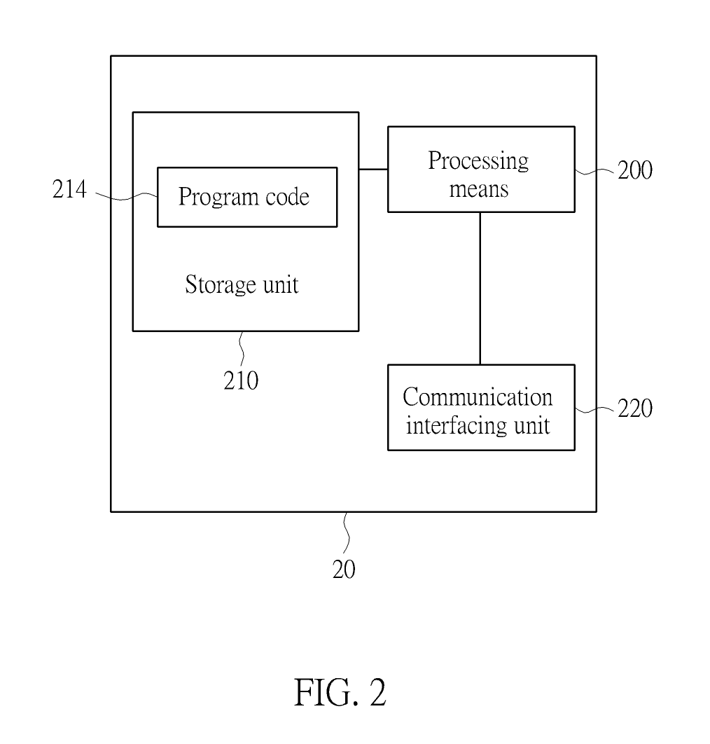

Please refer to FIG. 2, which is a schematic diagram of a communication device 20 according to an example of the present disclosure. The communication device 20 can be a communication device or the network shown in FIG. 1, but is not limited herein. The communication device 20 may include a processing means 200 such as a microprocessor or Application Specific Integrated Circuit (ASIC), a storage unit 210 and a communication interfacing unit 220. The storage unit 210 maybe any data storage device that can store a program code 214, accessed and executed by the processing means 200. Examples of the storage unit 210 include but are not limited to a subscriber identity module (SIM), read-only memory (ROM), flash memory, random-access memory (RAM), CD-ROM/DVD-ROM, magnetic tape, hard disk and optical data storage device. The communication interfacing unit 220 is preferably a transceiver and is used to transmit and receive signals (e.g., messages or packets) according to processing results of the processing means 200.

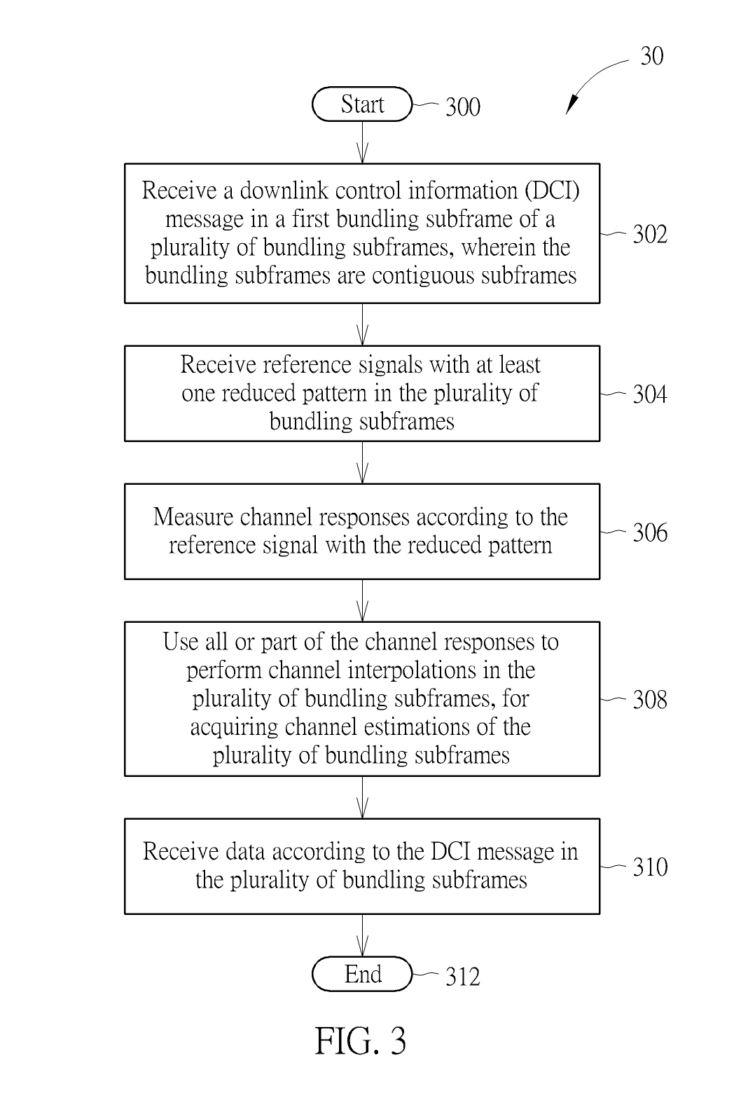

Please refer to FIG. 3, which is a flowchart of a process 30 according to an example of the present disclosure. The process 30 can be utilized in a communication device shown in FIG. 1, for reducing reference signals. In this example, the communication device is served by a small cell network (e.g. the network shown in FIG. 1). The process 30 maybe compiled into the program code 214 and includes the following steps:

Step 300: Start.

Step 302: Receive a downlink control information (DCI) message in a first bundling subframe of a plurality of bundling subframes, wherein the bundling subframes are contiguous subframes.

Step 304: Receive reference signals with at least one reduced pattern in the plurality of bundling subframes.

Step 306: Measure channel responses according to the reference signal with the reduced pattern.

Step 308: Use all or part of the channel responses to perform channel interpolations in the plurality of bundling subframes, for acquiring channel estimations of the plurality of bundling subframes.

Step 310: Receive data according to the DCI message in the plurality of bundling subframes.

Step 312: End.

According to the process 30, the communication device receives a downlink control information (DCI) message carried by a first bundling subframe of a plurality of bundling subframes via a downlink control channel. The DCI message may comprises the numbers and locations of scheduled Physical Resource Block (PRB) pairs, the modulation and coding scheme (MCS) and the number of used antenna ports, and the bundling subframes are contiguous subframes. Please note that, the number of the plurality of bundling subframes (hereinafter, the bundling size) may be changed according to different applications and design concepts. For example, the bundling size may be 2, 4 or 8 subframes, and is not limited herein. The bundling subframes share the same DCI message (e.g. the same numbers and locations of scheduled PRB pairs, the same MCS, the same number of used antenna ports and the same precoding method) received in the first bundling subframe. In such a condition, the communication device expects the same transmission format in the plurality of bundling subframes and receives the data in the plurality of bundling subframes with the same reception assumption. The overhead of the control information can be reduced, therefore. Note that, the data received in the plurality bundling subframes maybe different transport blocks but with the same transmission format.

Further, the communication device receives reference signals with at least one reduced pattern in the plurality of bundling subframes, wherein the reference signals may be the UE specific reference signals and the reference signals with the reduced pattern represents that the reference signals in each or some subframes of the plurality bundling subframes are reduced from the reference signals defined by the corresponding specifications (i.e. 3GPP rel-11 and its preceding specifications) and the number of occupied resource elements of the reference signals in each or some subframes of the plurality of bundling subframes is smaller than that of the reference signals defined by the corresponding specifications. It should be noted that although the number of occupied resource elements of the reference signals in each or some subframe of the plurality of bundling subframes is smaller than that of the reference signals defined by the corresponding specifications, the frequency/time location of the reference signals with the reduced pattern can be different from the reference signals defined by the corresponding specifications. Then, the communication device measures channel responses on the reference signals with the reduced pattern. Since each of the plurality of bundling subframes has the same locations of PRB pairs and the same transmission format (e.g. the same precoding method), the communication device can perform a channel interpolation in one of the plurality of bundling subframes by using the channel responses measured according to the reference signals of the other subframes in the plurality of bundling subframes, for improving the performance of the channel estimation acquired by the reference signals with the reduced pattern. The channel interpolation may be achieved by using different interpolation techniques, such as the linear interpolation or minimum mean square error (2D-MMSE) filter, and is not limited herein. Using the channel interpolation, the performance of the channel estimation achieved by the reference signal with the reduced pattern can be approximately the same with that of the channel estimation achieved by the reference signal defined in the corresponding specifications. After that, the communication device receives data according to the DCI message and the acquired channel estimations in the plurality of bundling subframes. As a result, the overhead of the control information and the reference signals can be reduced and the spectral efficiency of the wireless communication system can be improved without harming the performance of the channel estimation.

Please note that, the reference signals with the reduced pattern may be changed according to difference applications and design concepts. For example, the reference signals with the reduced pattern may be adapted according to the bundling size of the plurality of the bundling frames. Assuming the bundling size can be 2, 4 or 8, there are 3 different reduced patterns correspondingly for each subframe and every bundling subframe share the same reduced pattern. The reduced pattern corresponding to smaller bundling size has smaller number of occupied resource elements of the reference signals in each or some subframe of the plurality of bundling subframes than the reduced pattern corresponding to larger bundling size. With larger bundling size, there are more reference signals in the whole bundling subframes to be utilized. Therefore, it is reasonable that the number of the reference signals can be reduced more. In another example, if a hybrid automatic repeat request (HARQ) latency is not a concern for the communication device, each subframe can utilize the reference signals in all other subframes in the bundling subframes for deriving its own channel responses. Since the communication device can acquire the channel estimations of the plurality of bundling subframes after receiving all of the plurality of bundling subframes, the communication device may perform the channel interpolation in each bundling subframe according to the channel responses measured according to the reference signals of all or at least several bundling subframes. That is, the number of the reference signals being reduced is determined according to the bundling size. It is noted that the reduced pattern can be different in different bundling subframes.

In addition, if the HARQ latency is a concern for the communication device, the channel interpolation of a bundling subframe can only be performed by using the channel response measured according to the reference signals of itself and at least one past bundling subframes (i.e. the bundling subframes before itself). Since the latter bundling subframe of the plurality bundling subframe has more channel responses can be used for performing the channel interpolation, the number of the reference signals of the latter bundling subframe can be smaller. In other words, the number of the reference signals may be decreased according to the index of the plurality of bundling subframes. Note that, the number of the reference signals being reduced is also determined according to the bundling size. Please note that the first bundling subframe cannot utilize any other bundling subframes for deriving its own channel responses. As a result, it is possible that the first bundling subframe has no reduction on reference signals.

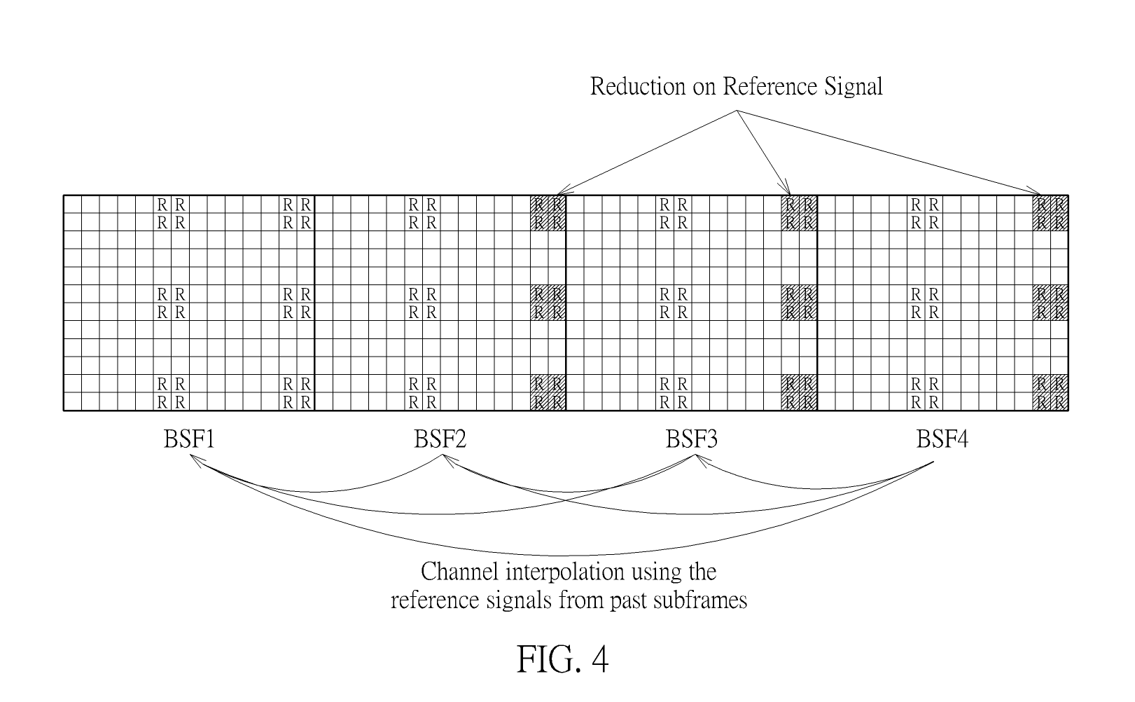

As to the detailed operations of the process 30 please refer to FIG. 4, which is a schematic diagram of bundling subframes BSF1-BSF4 according to an example of the present disclosure. The bundling subframes BSF1-BSF4 share the same DCI message received in the bundling subframe BSF1 (i.e. the first bundling subframe) and the communication device receives the data according to the same DCI message in the bundling subframe BSF1-BSF4. As shown in FIG. 4, the reference signals in the bundling frame BSF1 is not reduced, for avoiding channel estimation performance losses. Next, the communication device measures channels responses on the reference signals in the bundling subframes BSF1-BSF4. In the bundling subframe BSF2, the communication device may perform a channel interpolation via using the channel responses measured according to the reference signals of the bundling subframe BSF2 and/or the bundling subframe BSF1, to acquire the channel estimation in the bundling subframe BSF2. Similarly, in the bundling subframe BSF3, the communication device may perform the channel interpolation via using the channel responses measured according to the reference signals of the bundling subframes BSF3 and/or BSF1 and/or BSF2, to acquire the channel estimation of the bundling subframe BSF3, and so on. As a result, via the channel interpolation, the performance of the channel estimation measured according to the reference signals with the reduced pattern can be improved. Therefore, the overhead of the reference signals and the control information can be reduced and the spectral efficiency of the wireless communication system can be improved without harming the performance of the channel estimation.

Please note that, the reference signals of bundling subframes BSF1-BSF4 shown in FIG. 4 are only used for illustrating an example of the present disclosure. Those with ordinary skill in the art may accordingly observe appropriate alternations and modifications. For example, the reference signals in the bundling subframe BSF1 shown in FIG. 4 can be further reduced. In another example, since the channel interpolations performed in the bundling subframes BSF3 and BSF4 can use more channel responses measured in the past bundling subframes (e.g. the channel interpolations performed in the bundling subframe BSF3 may use the channel responses acquired in the bundling subframes BSF1 and BSF2 and the channel interpolations performed in the bundling subframe BSF4 may use the channel responses acquired in the bundling subframes BSF1-BSF3) than the bundling subframe BSF2, the reference signals in the bundling subframes BSF3 and BSF4 maybe further reduced.

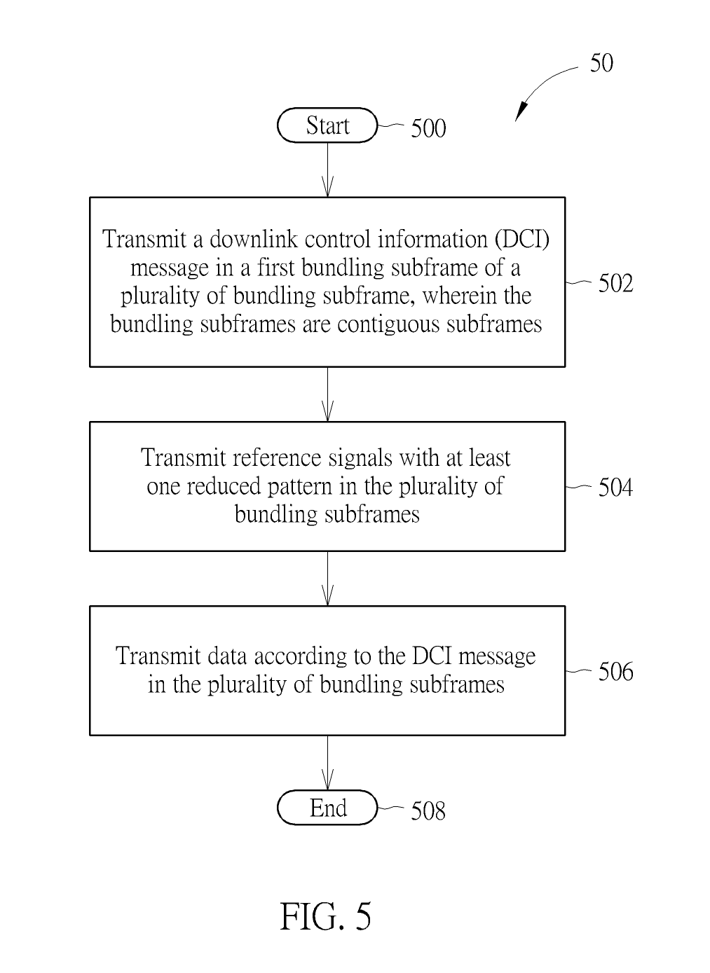

The detailed operations of the network performing the transmission to the communication device can be summarized into a process 50 as shown in FIG. 5. The process 50 can be utilized in a small cell network (e.g. the network shown in FIG. 1) for reducing reference signals. The process 50 may be compiled into the program code 214 and includes the following steps:

Step 500: Start.

Step 502: Transmit a downlink control information (DCI) message in a first bundling subframe of a plurality of bundling subframe, wherein the bundling subframes are contiguous subframes.

Step 504: Transmit reference signals with at least one reduced pattern in the plurality of bundling subframes.

Step 506: Transmit data according to the DCI message in the plurality of bundling subframes.

Step 508: End.

According to the process 50, the network transmits a DCI message carried by a first bundling subframe of a plurality of bundling subframes and transmits data according to the DCI message in all of the plurality of bundling subframes. The overhead of the control information can be reduced. Next, the network transmits reference signals with at least one reduced pattern in the plurality of bundling subframes, wherein the reference signals may be the UE specific reference signals and the reference signals with the reduced pattern represents that the reference signals of the plurality bundling subframes are reduced from the reference signals defined by the corresponding specifications and the number of the reference signals of the plurality of bundling subframes is smaller than that of the reference signals defined by the corresponding specifications. It should be noted that the frequency/time location of the reference signals with the reduced pattern can be different from the reference signals defined by the corresponding specifications. Since each of the plurality of bundling subframes has the same locations of PRB pairs and the same transmission format (e.g. the same precoding method) and the communication device can perform channel interpolations in the plurality of bundling subframe, the accurate channel estimations can be acquired according to the reference signals with the reduced pattern. As a result, the overhead of the reference signals can be reduced and the spectral efficiency of the wireless communication system 10 can be improved without harming the performance of the channel estimation. The reduced pattern can be selected by network according to the number of bundling subframes and/or the index of the bundling subframe. The detailed operations of the process 50 can be referred to the above description, and are not narrated herein for brevity.

Those skilled in the art should readily make combinations, modifications and/or alterations on the abovementioned description and examples. The abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 20.

To sum up, the present disclosure provides a method for reducing reference signals in a plurality of bundling subframes. Via sharing the same control information in the plurality of bundling subframes, the accurate channel estimations of the plurality bundling subframes can be acquired by the channel interpolations. The overheads of the control information and the reference signals are both reduced, therefore, and the spectral efficiency of the wireless communication system can be improved without harming the performance of the channel estimations.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of reducing a number of reference signals for a communication device in a wireless communication system, the method comprising:
receiving a downlink control information (DCI) message in a first bundling subframe of a plurality of bundling subframes, wherein the bundling subframes are contiguous subframes;
receiving reference signals with at least one reduced pattern in the plurality of bundling subframes, wherein a number of the reference signals with the reduced pattern is smaller than a number of the reference signals determined in corresponding specifications;
measuring channel responses according to the reference signals with the reduced pattern;
using the channel responses to perform channel interpolations in the plurality of bundling subframes, for acquiring channel estimations of the plurality of the bundling subframes; and
receiving data according to the DCI message in the plurality of bundling subframes.

2. The method of claim 1, wherein the reference signals are user equipment (UE) specific reference signals.

3. The method of claim 1, wherein the communication device is served by a small cell network.

4. The method of claim 1, wherein the step of using the channel responses to perform the channel interpolations in the plurality of bundling subframes, for acquiring the channel estimations of the plurality of the bundling subframes comprises:
using all the channel responses to perform the channel interpolations in all of the plurality of bundling subframes, for acquiring the channel estimations of the plurality of the bundling subframes.

5. The method of claim 1, wherein the step of using the channel responses to perform the channel interpolation in the plurality of bundling subframes, for acquiring the channel estimations of the plurality of the bundling subframes comprises:
using the channel responses of a second bundling subframe and at least one of the preceding bundling subframes of the second bundling subframe to perform the channel interpolation in a second bundling subframe of the plurality of bundling subframes, for acquiring the channel estimation of the second bundling subframe of the plurality of the bundling subframes.

6. The method of claim 5, wherein the number of reference signals of each bundling subframe is decreased according to the index in the plurality of bundling subframes.

7. The method of claim 1, wherein the reduced pattern changes according to a number of the plurality of bundling subframes and/or the index of the plurality of bundling subframes.

8. A method of reducing reference signals for a network of a wireless communication system, the method comprising:
transmitting a downlink control information (DCI) message in a first bundling subframe of a plurality of bundling subframes, wherein the bundling subframes are contiguous subframes;
transmitting reference signals with at least one reduced pattern in the plurality of bundling subframes, wherein a number of the reference signals with the reduced pattern is smaller than a number of the reference signals determined in corresponding specifications; and
transmitting data according to the DCI message in the plurality of bundling subframes.

9. The method of claim 8, wherein the reference signals are user equipment (UE) specific reference signals.

10. The method of claim 8, wherein the network is a small cell network.

11. The method of claim 8, wherein a number of reference signals in each bundling subframe is decreased according to the index in the plurality of bundling subframes.

12. The method of claim 6, wherein the reduced pattern changes according to a number of the plurality of bundling subframes and/or the index in the plurality of bundling subframes.
